(19) United States
(12) Patent Application Publication
(10) Pub. No.: US 2010/0102991 A1
(43) Pub. Date: Apr. 29, 2010

(54) PEDESTRIAN CROSSING WITH PRESENCE DETECTOR AND WARNING

(76) Inventors: Ana María Hernández González, Alicante (ES); Salvador Camarasa Gómez, Yecla (Murcia) (ES); Pascual Martínez Ibáñez, Alicante (ES)

Correspondence Address: WENDEROTH, LIND & PONACK, L.L.P., 1030 15th Street, N.W.,, Suite 400 East, Washington, DC, 20005-1503, US

(21) Appl. No.: 12/593,343

(22) PCT Filed: Mar. 27, 2008
(86) PCT No.: PCT/ES08/00174

§ 371 Date: Dec. 31, 2009

(30) Foreign Application Priority Data
Mar. 27, 2007 (ES) P200700805

(51) Int. Cl. G08G 1/095

(52) U.S. Cl. 340/944

(57) ABSTRACT

Pedestrian crossing with presence detector and warning, characterised in that it constitutes an independent and transportable constructive element, easy to assemble and dismantle, with low maintenance cost, equipped with presence detectors, warning devices, power supply system, accumulators and electronic devices (circuitry, etc.), which detects pedestrians, vehicles, or both, in a crossing zone, and alerts both drivers and pedestrians themselves, of their respective presence on said crossing, or in the proximity thereto, and provides greater road safety, reduces the risk of accidents for pedestrians due to inclement weather, reduces acoustic contamination and gives greater versatility to the use of public roads, also has uses in fixed pedestrian crossings in the form of total or partial introduction of the different elements constituting the invention or in the form, for example, of total or partial shelters for fixed crossings incorporating said elements.

### OBJECT OF THE INVENTION

The present descriptive specification concerns an Invention patent relating to a pedestrian crossing provided with a presence detection system, which permits both the detecting of pedestrians and of vehicles approaching the crossing, with both systems being able to be combined or presented separately; so, with regard to the detection of pedestrians, the proposed invention permits on the one hand the detection of the presence of a pedestrian located on the crossing or in a position immediately next to it, and on the other hand, once the pedestrian has been detected, the emitting of a signal, preferably of a luminous and/or acoustic nature, which alerts both the vehicles and the pedestrians themselves, warning the former of the presence of a pedestrian on the crossing and warning the latter so that the pedestrian (with an acoustic signal in case he or she is blind) can be sure that the crossing has alerted the vehicle, as well as confirming for the pedestrian that this is an appropriate place to cross; as far as the detection of vehicles is concerned the concept is the same, and the invention that is advocated would, on the one hand, permit detection of the vehicle as it approaches the pedestrian crossing and, on the other hand, alert the pedestrian to the proximity of the vehicle so that he or she can take the greatest care when crossing. In turn, said crossing is configured either as an independent constructive element which represents an enormous simplification and improvement in the location of pedestrian crossings, or as a modification to a fixed pedestrian crossing which is provided with all or part of the characteristic elements of the invention.

### FIELD OF THE INVENTION

This invention has its application within the auxiliary industry for construction, in particular the construction of public roads.

### BACKGROUND OF THE INVENTION

Various forms of the prior art are known referring to pedestrian detection systems on zebra crossings, or pedestrian crossings, and for alert aimed both at vehicles and at the pedestrians themselves.

Among this prior art we can cite U.S. Pat. No. 6,384,742, German DE 2004 006444, Japanese JP 6299519 and several others of a similar nature, and there even exist Spanish prior art such as Utility Model ES 200400236.

All this prior art basically consists of detection systems that are usually employed for other purposes (laser detectors, for example, used in border zones) or in warning systems (push-buttons located in the pedestrian crossing), which are external to the pedestrian crossing itself, in other words, they conceive the pedestrian crossing as being a certain place on the roadway provided for and identified and signed for the crossing of pedestrians.

Nevertheless, none of the cited prior art conceives the zebra crossing as an independent constructive element which, of course, in located on the public road in the place designated for the crossing of pedestrians but which does not form an inseparable part of it or which, adapting an already existing fixed crossing, incorporates all or part of the systems which the invention describes, in particular, pressure sensors, since none of the prior art describes the pressure sensors that characterise the present invention.

Indeed, the invention that is proposed starts from the basis of a novel independent constructive element, though it admits the adaptation of fixed pedestrian crossings, carried out in different materials, though preferably rubber, being fitted with appropriate detection and alerting elements in order to perform its function, and which can be located in a zone of the public road, and later on be moved to another zone, and even be portable for use in zones where road works are in progress.

There exists different prior art consisting of independent constructive elements used on public roads, as in the case of sound bands, generally created in rubber or plastics, intended to reduce the speed of vehicles as they approach risk zones (pedestrian crossings, dangerous bends, residential areas) and which are even provided with reflecting or catadioptric elements. We have also detected even constructive elements such as that described in Utility Model ES 199801095, consisting of a metallic platform, which is placed in front of the zebra crossing and is operated by a push-button which the pedestrian presses and which activates a lighting system alerting vehicles that are approaching the crossing.

These systems also do not anticipate the object of the present invention, on the one hand because it concerns different constructive elements, and on the other because they either lack the detection system, or the alert system or both, or they include some system that is completely different from that described by the invention being proposed.

The invention that is proposed offers us in all senses a clear advantage over the traditional pedestrian crossings, which are located on our public roads with cement or derived substances, though it also permits the adaptation of these.

So, because of its design it is easy to assemble and dismantle, without any need for this to be done by specially qualified people.

It can be manufactured totally or partially with waste products from other articles, which have been recycled and returned to society for use.

Furthermore, the characteristics of the material used for its manufacture will prevent the slippery effect caused by rain. Currently, crossings finished with cement find that their surfaces become polished due to the passage of vehicles, which causes constant slipping of pedestrians who cross it, mostly among the elderly, who are those with least capacity for reaction to slipping and who, on account of their age, have most difficulties in recovering from their injuries.

The material that is used also has a greater absorption than cement when impacted by a vehicle and will therefore emit less noise when the vehicle crosses it, thus reducing acoustic contamination.

It contributes very specially to road safety and therefore helps to reduce accidents involving pedestrians being run over.

It prevents continual maintenance in relation to imperfections (detachments or breakage in the structure) and repainting of surfaces, since it is manufactured directly in the appropriate colour and its wear depends on the resistance of the material. This will avoid the situation that currently occurs with most zebra crossings, which are continually darkening and fail to comply with their task of providing proper protection for pedestrians since they scarcely manage to attract attention.

It allows Local Councils not to have their streets completely unused because there is a pedestrian crossing in them. If a Local Council with present-days crossings is interested in having a sports event pass along that road (cycle race or any kind of vehicle race, etc.), then it either has to seek alternative routes, or make costly modifications, or simply not hold the race. With this product it is very easy to solve this problem for a street or avenue and, once the event has finished, the crossings are again installed so that they can carry on performing their task.

### DESCRIPTION OF THE INVENTION

The pedestrian crossing with presence detector and warning, which the present invention proposes, is constituted on the basis of an independent constructive element making up the actual pedestrian crossing, or on the basis of adapting a fixed pedestrian crossing, and is endowed with a range of elements comprising it:

1. —The pedestrian crossing itself.
2. —Presence detectors.

### 3. —Warnings.

4. —Power supply system.

### 5. —Accumulators.

6. —Electronic devices (circuitry, etc.).
1. —The pedestrian crossing itself, as the constructive element, is designed as an independent constructive element, easy to assemble and dismantle, in which the other elements are incorporated, being created in any material though preferably those which can withstand the action of the environment and the rigour of the traffic, and which will reduce the risk of skidding or slipping on damp surfaces, and in cases in which they are mobile, those which permit less weight in order to facilitate their transportation, notable here being recycled vulcanised rubber. In the latter case, its manufacture requires a process of injection, extrusion and/or moulding with a mould, and can be carried out in accordance with the measurements of the crossing in question.

The pedestrian crossing itself has a suitable design for permitting drainage of water as well as approach or access ramps for the disabled, and it occupies the entire space of the roadway and possibly also part of the pavement.

Likewise, the pedestrian crossing itself can be designed to include approach ramps with angles suited for vehicles and which do not imply any obstacle, acting instead as a regulation element for the traffic. In this sense, the crossing could be provided with a zone (face exposed to impact from the vehicle) which would absorb the energy of the vehicle, if it is considered that it ought to be included in the actual crossing itself, by means of using materials capable of absorbing that energy or by using a suitable design that will produce that effect (deformation of the element, surface design that improves the grip of the tyre to the element, etc.), or if it is a prior element (though forming part of the actual crossing) by way of an energy absorber with a shape similar to the actual crossing, bands located on the ground, materials with the capacity to absorb the energy of impact or surfaces with designs capable of providing that effect.

The pedestrian crossing itself can be provided with the necessary elements for regulation of its height and can be adapted to the different levels of pavements, streets, roads, etc.

The pedestrian crossing itself, though characterised by its mobility, being able to be lifted up and removed in order to facilitate transit (heavy vehicles, cycle races, etc.), can take on the form of reduced or lightened crossings, with even greater mobility, being able to be used in zones where there are road works, etc.

They will also be able to be raised up laterally in order to create a physical barrier, allowing the street to be cut off by the local police, the fire brigade, etc., without any need to take barricades of any kind to the location (FIG. 4).

The crossing includes the possibility of permitting the flow of rainwater, meltwater from snow, etc., and therefore prevent the formation of an architectural barrier so that the water ends up by overflowing onto the pavements.

In the case in which the crossing has to be located in spaces that do not coincide with the actual geometry of the element constituting the zebra crossing, the possibility is considered of filling in those spaces with suitable materials, in particular with polymer materials of a nature similar to the actual material used for creating the crossing, such as for example filling with rubber and its later vulcanisation.

The pedestrian crossing itself includes other elements making up the assembly, which are arranged in the manner described in relation to each of them.

In addition to those elements which are described below, in the configuration of the pedestrian crossing on the ground different areas are distinguished: the approach zone for pedestrians (1), the roadway (2), peripheral zone of activity of the presence sensors (4), and pedestrian crossing zone (5).

2. —Presence detectors: The pedestrian crossing that is advocated includes different types of sensors (10) which permit the detection of the presence of a pedestrian, or of a vehicle, and which can be presented jointly or separately, with different systems for pedestrian detection, or vehicle detection, or detection of pedestrian and vehicles, being able to be accumulated together, which grants the invention greater versatility. So, it can be provided with pressure sensors that are piezoceramic, capacitive, conducting rubber, photoelectric, optical, laser, etc., both for detection of pedestrians and for vehicles, or consisting of a combination or all or some of them.

The pressure sensors (piezoceramic, etc.) for the detection of pedestrians are preferably located in the interior part (11) of the base of the pedestrian crossing itself, though they can also be located on a surface zone thereof, and they are activated by the presence of a pedestrian on the surface (4, 5) of the zebra crossing, which detects the pressure exerted by the crossing of the pedestrian, with the warning system being automatically activated. Optical or laser sensors are nevertheless located in the exterior part and their functioning takes place by detection of the pedestrian when he or she comes within their range.

Their essential function is to detect the presence of the pedestrian and activate the warning or alert system.

The sensors can also be located in the peripheral zones (4) of activity, as might be the access ramp if one exists, or the first access stripe of the crossing.

In the case of sensors for vehicle detection (9), the function is the reverse, in other words, the sensor detects the vehicle and activates the warning system for the pedestrian, and is recommended for use in zones that are badly lit, areas around schools in order to indicate that the crossing must not be crossed—by means of light or acoustic indicators—and areas where there are elderly people, etc.

The sensors can also be of different types and in the case of piezoceramic or piezoelectric sensors, bands are used located at a suitable distance from the crossing and connected to it (including forming part of the constitutive element of the sensor).

The laser or optical technology would act in the same way as with pedestrian detection sensors, focusing their coverage on the roadway in the approach zones for vehicles, and at a suitable distance.

3. —Warnings: The detection of the pedestrian has to cause the triggering of a warning or alert system, aimed both at the pedestrian and at the driver.

So, the alert system consists of a signal, which can be light emission (by means of the flashing of the type high luminosity, low consumption LEDs, etc.) or acoustic (loudspeakers, etc.), or electronic, or a combination of all of them, whether they are included in the pedestrian crossing itself or are also able to be connected to it in the manner of peripherals.

The warnings are aimed both at the drivers (7), so that by means of the emitted signals they are able to perceive the alert for the presence of a pedestrian on the zebra crossing, and also at the actual pedestrians (7, 8), allowing them to recognise the crossing in the case of the disabled as well as the approach of a vehicle so that they can take the greatest of care when crossing.

The light signals can adopt a different configuration with the aim at all times of preventing two lights from being on at the same time in order to prevent unnecessary consumption.

Equally, the crossing can also have a longitudinal signal (6) incorporated into the crossing in order to indicate the crossing zone in places that are poorly lit with prior activation due to presence.

The form of the optical and sound signals would indicate the direction in which the vehicles (3) are circulating and the direction from which the pedestrian is approaching the crossing (information for the driver of the vehicle (1).

The electronic signals consist of any kind of signal, such as radiofrequency signals, Bluetooth or similar, which alert the vehicle to the proximity of a pedestrian crossing.

As far as possible, in the case of optical warnings the aim will be to place them in zones of the crossing or in the form of peripherals permitting a vertical location, since it has been demonstrated that vertical format warnings are more effective than horizontal ones.

4. —Power supply system: The unit is provided with a power supply system which can be of different kinds, from supply by connection to the general network or even using autonomous systems, such as might be solar power, induction by mechanical action of the vehicles on the crossing, the use of piezoelectric polymers, etc.

The use of autonomous systems on the one hand facilitates their installation in areas with road works, or which are difficult to be accessed by the general network, and on the other hand they also contribute towards achieving the objectives concerning savings in non-renewable energies.

Power supply by means of induction due to the mechanical action of vehicles on the crossing, which permits the energy produced by the vehicle to be exploited, due fundamentally to its weight on the crossing, is based on the principle of the capacity which variations in a magnetic field have for producing electric fields and electric currents. For that reason, in this case the system would consist of electromagnetic elements, coils, and electrical and electronic devices.

5. —Accumulators: Autonomous power supply systems require the presence of batteries and/or capacitors which have also been provided for in this invention. Systems connected to the electrical network can opt for having a system of accumulation during off-peak tariff hours.
6. —Electronic devices (circuitry, etc.): The entire unit is provided with the corresponding circuits, which permit the unit to be supplied with power, functioning of the sensors, interaction and activation of the warnings, and the functioning of the latter so that they can comply with their purpose. This set of circuitry is composed of the combination of sensors, of physical connections by means of cabling, metallic elements included in the pieces by way of connectors, etc. And all this is in turn connected to the mechanical and electronic elements and to the electronic control elements which complete and transform the pedestrian crossing into an active element on the road. All in all, a mechanical signal is converted into an electrical signal, which in turn activates the optical and acoustic elements, and by means of the electronic control elements it manages the power supply and energy consumption of the device.

In the configuration as a fixed pedestrian crossing, the assembly of the invention is very similar and is made up of the same elements with the exception of the constructive element or the pedestrian crossing itself.

In particular, it can present all or part of the following elements:

Presence detectors.

Warnings.

Power supply system.

Accumulators.

Electronic devices (circuitry, etc.).

The configuration of the assembly is carried out on the basis of the incorporation of all or part of those elements as described above, into a fixed pedestrian crossing, in which the appropriate works will have to be carried out or in the manner of a shelter.

The incorporation of the pressure sensors can be carried out directly in the crossing itself or by means of the addition of a layer of any material, though preferably rubber or similar, provided with the appropriate sensors.

### DESCRIPTION OF THE DRAWINGS

For a better understanding of the object claimed, its representation will now be proceeded with by means of three plans in which, on an illustrative and non-limiting basis, the following has been represented:

FIG. 1 shows a representation in plan view showing the functioning arrangement of the pedestrian crossing with presence detector and warning, referring to the detection of a pedestrian.

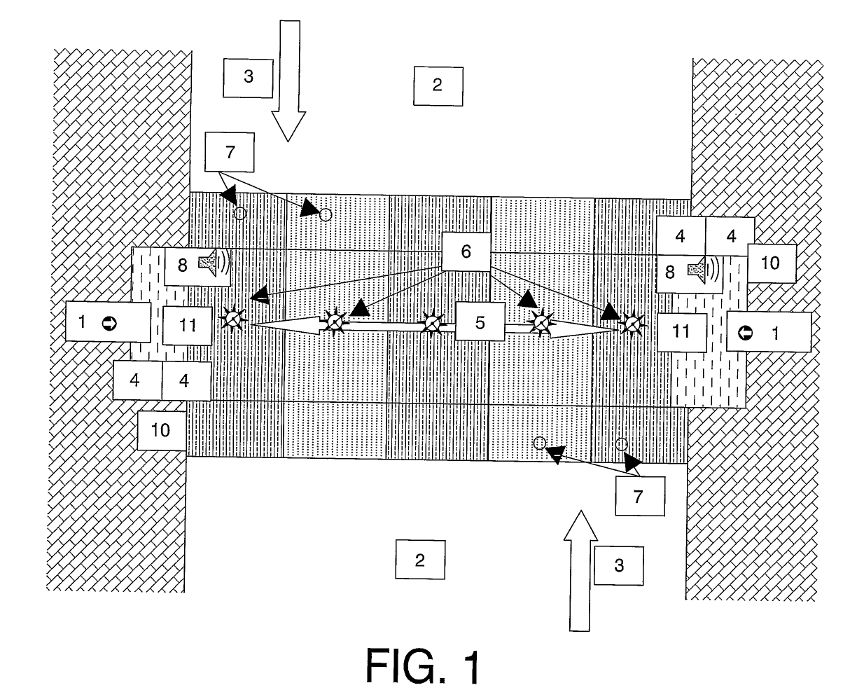

FIG. 2 shows a representation in elevation view of the pedestrian crossing with presence detector and warning, referring to the detection of a pedestrian.

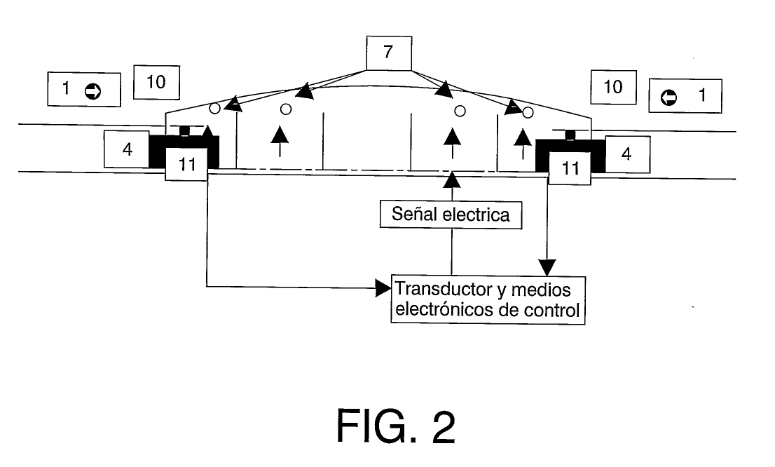

FIG. 3 shows the plan view of the pedestrian crossing with presence detector and warning in which can be seen the different elements making it up, referring to the detection of a vehicle.

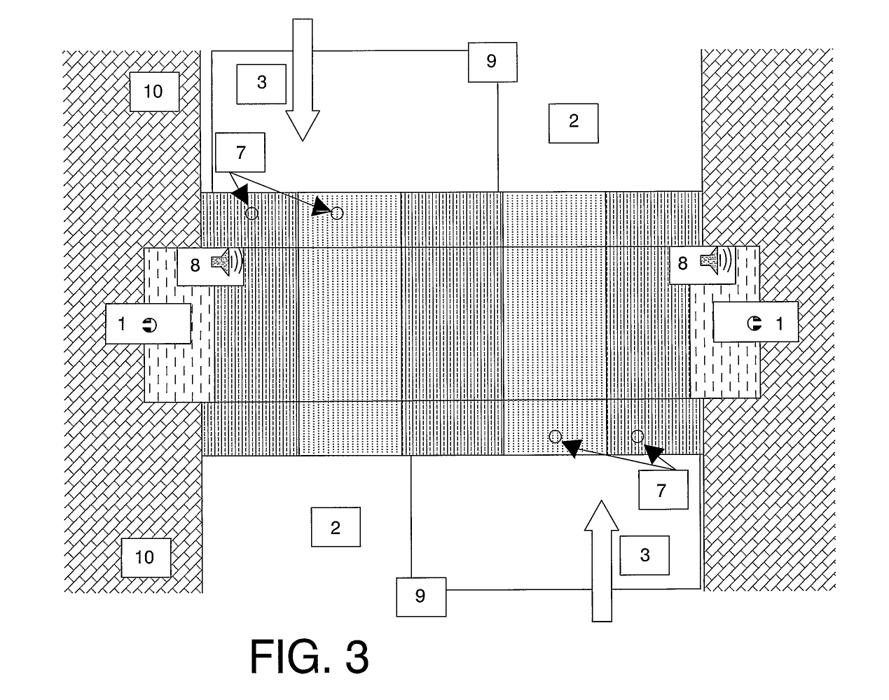

FIG. 4 shows the swinging system of the crossing.

### PREFERRED EMBODIMENT OF THE INVENTION

### Example 1

On a public road in the area of the roadway (2), intended for the crossing of pedestrians (5), the pedestrian crossing is positioned with presence detector and warning, endowed with the different elements making it up.

This crossing is either connected to the general electrical network or on the other hand its functioning takes place based on autonomous systems for energy generation according to each case.

In a city area, with general network connectors, and assuming the lesser maintenance requirements that this supply system implies, the described assembly is located in the zone intended for a zebra crossing and is endowed with the following elements:

The pedestrian crossing itself created in recycled vulcanised rubber and which is subjected to the corresponding process of injection, extrusion and/or moulding by means of mould, and with the appropriate measurements, occupying the entire roadway (2) and part of the pavement on both sides, being provided with access ramps for the disabled on both sides thereof in the approach zone for the pedestrian (1). The pedestrian crossing presents a design that permits the drainage of water, and at the same time its material reduces the risks of slipping for pedestrians in the event of rain, or when the surface is wet, as well as reducing the risk of skidding for cars.

The interior part (11) of the base of the pedestrian crossing, in the approach zone of the zebra crossing for pedestrians (1) includes some piezoceramic pressure sensors (10) and at the moment a pedestrian is located on any part of the crossing, in any of the zones on the pavement (1), or the crossing zones located on the roadway (5), the sensors pick up the pressure exerted by the weight of the pedestrian and detect his or her presence.

The sensors immediately activate the alert system, made up of optical warnings, consisting of the flashing of the type high luminosity, low consumption LEDs located along both sides of the crossing and perpendicular to the roadway, which alert the driver to the presence of the pedestrian (7). Parallel with this, some acoustic warnings (8) are activated which inform the pedestrian that he or she is on a pedestrian crossing and other optical warnings (6) are activated which indicate the crossing zone (5).

The system of supply by means of connection to the general network does not in theory require the use of accumulators, batteries, etc., though their use cannot be discarded in cases in which they are charged during off-peak tariff hours in the way that overnight storage heaters do.

The entire assembly functions on the basis of interior circuits which connect up the different elements transforming the pedestrian crossing into an active element on the roadway.

### Example 2

In another preferred mode of embodiment, in a zone with road works where there is no general electrical network and a temporary crossing for pedestrians is required on account of the deviation, also temporary, of the public road, the installation of a pedestrian crossing becomes necessary.

So, the pedestrian crossing is installed created in recycled vulcanised rubber (though not exclusively with this material), occupying part of the roadway (2) and part of the pavement (1) being provided on both sides thereof with access ramps for the disabled.

Due to the irregular nature of the ground, and the fact that it does not cover all the roadway and pavement where a pedestrian (1) might tread, although the interior part (11) of the base of the pedestrian crossing includes piezoceramic pressure sensors (10), these are combined with some laser, optical or other detectors which are placed in some posts oriented towards the zones not covered by the pressure sensors.

So, when a pedestrian is located on the pedestrian crossing, in any of the zones of activation of the pressure sensors (10) and (4), or within range of the optical sensors (4), these detect his or her presence and start up the alert systems, consisting of both optical and acoustic warnings (6), (7) and (8).

The pedestrian crossing, which is transportable, can be removed at any moment once it is no longer needed, or it can even be removed momentarily for the passage of heavy vehicles, or on account of leisure activities, the passage of a cycle race, etc.

### Example 3

On a public road of particular danger due to being in an area with schools, in a zone intended for the passage of pedestrians, especially children, the pedestrian crossing is located with presence detector and warning, provided with the different elements comprising it, and in particular being provided with presence sensors both for pedestrians and for vehicles (10) and (9).

This crossing is either connected to the general electrical network or on the other hand its functioning takes place based on autonomous systems for energy generation according to each case.

In a city area, with general network connectors, and assuming the lesser maintenance requirements that this supply system implies, the described assembly is located in the zone intended for a zebra crossing and is endowed with the following elements:

The pedestrian crossing itself created in recycled vulcanised rubber and which is subjected to the corresponding process of injection, extrusion and/or moulding by means of mould, and with the appropriate measurements, occupying the entire roadway (2) and part of the pavement on both sides (1), being provided with access ramps for the disabled on both sides thereof. The pedestrian crossing presents a design that permits the drainage of water, and at the same time its material reduces the risks of slipping for pedestrians in the event of rain, or when the surface is wet, as well as reducing the risk of skidding for cars.

The interior part of the base of the pedestrian crossing (11), in the approach zone of the zebra crossing for pedestrians (1) includes some piezoceramic pressure sensors (10) and at the moment a pedestrian is located on any part of the crossing, in any of the zones on the pavement or of the roadway (1), (4), (5), the sensors pick up the pressure exerted by the weight of the pedestrian and detect his or her presence.

The sensors immediately activate the alert system, made up of optical warnings (7), consisting of the flashing of the type high luminosity, low consumption LEDs located along both sides of the crossing and perpendicular to the roadway, which alert the driver to the presence of the pedestrian. Parallel with this, some acoustic warnings (8) are activated which inform the pedestrian that he or she is on a pedestrian crossing.

The crossing in turn has some vehicle detection sensors (9), consisting of bands made of rubber, located at a suitable distance, the lower part of which include some pressure sensors that are piezoceramic, piezoelectric, etc., and when a vehicle runs over those bands with its wheels the sensors pick up the pressure exerted by the weight of the vehicle and detect its presence. These sensors are accompanied by some optical sensors formed from separate columns which include equipment suitable for the detection of the vehicle before it reaches the bands with the pressure sensors.

The sensors, whether they be pressure or optical, or both, immediately activate the alert system, made up of optical warnings, consisting of the flashing of the type high luminosity, low consumption LEDs located along both sides of the crossing and parallel to the pavement, which alert pedestrians to the presence of the vehicle. Parallel with this, some acoustic warnings (8) are activated which inform the pedestrian of the presence of the vehicle.

The system of supply by means of connection to the general network does not usually require the use of accumulators, batteries, etc., though their use cannot be discarded in cases in which they are charged during off-peak tariff hours in the way that overnight storage heaters do.

The entire assembly functions on the basis of interior circuits which connect up the different elements transforming the pedestrian crossing into an active element on the roadway.

1-16. (canceled)

17. Pedestrian crossing with automatic presence detector and warning of pedestrians or vehicles, characterised in that it constitutes a constructive element independent of the surface of the roadway and transportable, which includes presence detectors, warning devices, a power supply system selected from a system that includes accumulators and a system that does not include accumulators, and electronic devices (circuitry, etc.), which permits the detection of pedestrians, vehicles, or both, in a crossing zone, and alerts both drivers and pedestrians themselves of their respective presence on said crossing; the presence detectors being of the type of pressure sensor selected from between piezoceramic, piezoelectric, capacitive, conducting rubber and a combination of the same; and being activated by the presence of the pedestrian or vehicle on a surface of the constructive element on detecting the pressure exerted by the weight of the pedestrian or of the vehicle on that surface of the constructive element and automatically activating the warning devices;
the constructive element comprises ramps for the attack of vehicles, height regulators, drainage systems and access systems for the disabled.

18. Pedestrian crossing with automatic presence detector and warning of pedestrians or vehicles, according to claim 17, characterised in that the piezoceramic pressure sensors (10) are located in a position selected from between the interior part (11) of the base of the pedestrian crossing itself and a surface zone of the crossing.

19. Pedestrian crossing with automatic presence detector and warning of pedestrians or vehicles, according to claim 18, characterised in that the constructive element comprises some bands in the lower part of which are installed the piezoceramic pressure sensors (9); the bands being located on the roadway at a distance from the crossing.

20. Pedestrian crossing with presence detector and warning, according to claim 17, characterised in that it presents a warning or alert system aimed both at the pedestrian and at the driver which is activated as a consequence of the detection of the pedestrian or of the vehicle by the presence sensors, and consists of a signal, understood as being light emission (by means of the flashing of the type high luminosity, low consumption LEDs, etc.), acoustic (loudspeakers, etc.), or electronic, or a combination of all of them, whether they are included in the crossing itself or are also able to be connected to it in the manner of peripherals.

21. Pedestrian crossing with presence detector and warning, according to claim 20, characterised in that the warning signals can indicate both the presence of a vehicle (8) or of a pedestrian (7), as well as indicating the crossing zone (6) in places that are poorly lit with prior activation due to presence, being regulated in such a way that two light signals are not lit at the same time in order to prevent unnecessary consumption.

22. Pedestrian crossing with presence detector and warning, according to claim 20, characterised in that the form of the optical and sound signals will indicate the direction in which the vehicles (3) are circulating and the direction from which the pedestrian is approaching the crossing (1).

23. Pedestrian crossing with presence detector and warning, according to claim 20, characterised in that the electronic signals consist of any kind of signal, such as radiofrequency signals, Bluetooth or similar, which alert the vehicle to the proximity of a pedestrian crossing.

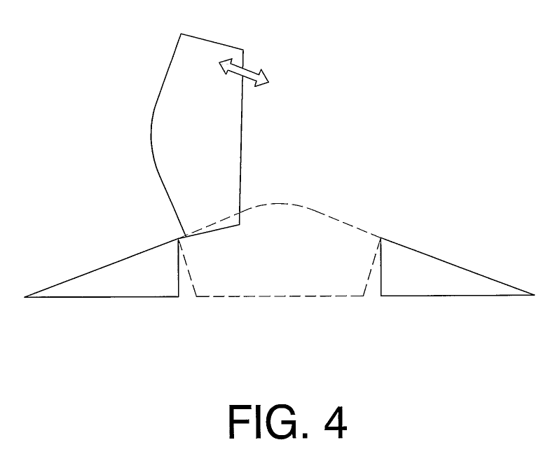

24. Pedestrian crossing with presence detector and warning, according to claim 17, characterised in that it is able to be raised up on one side in order to create a physical barrier (FIG. 4).

25. Pedestrian crossing with presence detector and warning, according to claim 17, characterised in that it is provided with a power supply system which can be dependent, of the general electrical network type, or independent or autonomous, of the type solar energy, induction by mechanical action of the vehicles on the crossing, use of piezoelectric polymers, etc.

26. Pedestrian crossing with presence detector and warning, according to claim 25, characterised in that in the case of autonomous systems the assembly presents the corresponding batteries and/or capacitors, and in the case of systems connected to the electrical network they can opt for having a system of accumulation during off-peak tariff hours.

27. Pedestrian crossing with presence detector and warning, according to claim 25, characterised in that it has an induction system by the mechanical action of the vehicles on the crossing, which permits the energy produced by the vehicle to be exploited, due primarily to its weight on the crossing, in order to feed the detection and signalling systems which the crossing is provided with.

28. Pedestrian crossing with presence detector and warning, according to claim 17, characterised in having a circuit of electronic devices (circuitry) provided with physical connections by means of cabling and metallic elements included in the pieces by way of connectors which connect all the mechanical and electronic elements of the system, and this to the power supply network, which transforms the pedestrian crossing into an active element on the road and which transforms and controls a mechanical signal into an electrical signal, which in turn activates the optical and acoustic elements, and which by means of the electronic control elements manages the power supply and energy consumption of the device.

29. Pedestrian crossing with presence detector and warning, according to claim 17, characterised in that it permits the adaptation of a fixed and already existing pedestrian crossing into a pedestrian crossing with presence detector and warning, by means of the incorporation into said crossing, either independently or in the form of a shelter, of all or part of the following elements: presence detectors; warning devices; power supply system; accumulators; electronic devices (circuitry, etc.), which permits the detection of pedestrians, vehicles, or both, in a crossing zone, and alerts both drivers and pedestrians themselves of their respective presence on said crossing, or in proximity thereto.

30. Pedestrian crossing with presence detector and warning, according to claim 29, characterised in that the incorporation of the pressure sensors can be carried out directly in the crossing itself or by means of the addition of a layer of any material, though preferably rubber or similar, provided with the appropriate sensors.
